(19) United States
(12) Patent Application Publication
(10) Pub. No.: US 2026/0321186 A1
(43) Pub. Date: Oct. 15, 2026

(54) DISPLAY DEVICE, COMPENSATION SYSTEM OF DISPLAY DEVICE, AND METHOD FOR DETERMINING COMPENSATION VALUES

(71) Applicants: Chengdu BOE Optoelectronics Technology Co., Ltd., Chengdu, Sichuan (CN); BOE Technology Group Co., Ltd., Beijing (CN)

(72) Inventor: Chao ZENG, Beijing (CN)

(21) Appl. No.: 18/836,030

(22) PCT Filed: Nov. 29, 2023
(86) PCT No.: PCT/CN2023/135152

§ 371 Date: Aug. 6, 2024

(51) Int. Cl. G09G 3/32

(52) U.S. Cl. CPC G09G 3/32; G09G 2320/0233

(57) ABSTRACT

Provided is a display device, including a display panel, a first control assembly, and a memory, wherein the display panel includes a substrate, and a target circuit structure and a plurality of light-emitting units; the memory stores target compensation values for a plurality of sub-pixels in the second display region, wherein the target compensation values for the plurality of sub-pixels are compensation values corresponding to the target circuit structure; the first control assembly is configured to obtain the target compensation values for the plurality of sub-pixels from the memory and compensate for the plurality of sub-pixels in the second display region based on the target compensation values, wherein the target compensation values at the first specified luminance are configured to make a luminance difference between the plurality of sub-pixels in the second display region and sub-pixels in the first display region conform to target luminance data.

The present disclosure is a U.S. national stage of international application No. PCT/CN2023/135152, filed on Nov. 29, 2023, the disclosure of which is herein incorporated by reference in its entirety.

### TECHNICAL FIELD

The present disclosure relates to the field of display technologies, and in particular to a display device, a compensation system of a display device, and a method for determining compensation values.

### BACKGROUND

Display devices are devices capable of achieving a display function.

### SUMMARY

Embodiments of the present disclosure provide a display device, a compensation system of a display device, and a method for determining compensation values. The technical solutions are as follows.

According to some embodiments of the present disclosure, a display device is provided. The display device includes a display panel, a first control assembly, and a memory, wherein the display panel includes a substrate, and a target circuit structure, and a plurality of light-emitting units which are disposed on the substrate, wherein the substrate is provided with a second display region and a first display region outside the second display region; the plurality of light-emitting units are disposed in both the second display region and the first display region; and the target circuit structure is electrically connected to the plurality of light-emitting units;
the memory stores target compensation values for a plurality of sub-pixels in the second display region, and the target compensation values for the plurality of sub-pixels are compensation values corresponding to the target circuit structure;
the first control assembly is configured to obtain the target compensation values for the plurality of sub-pixels from the memory and compensate for the plurality of sub-pixels in the second display region based on the target compensation values for the plurality of sub-pixels; and
the target compensation values for the plurality of sub-pixels include target compensation values for the plurality of sub-pixels at first specified luminance, wherein the target compensation values at the first specified luminance are configured to make a luminance difference between the plurality of sub-pixels in the second display region and sub-pixels in the first display region conform to target luminance data upon compensating for the plurality of sub-pixels in the second display region.

In some embodiments, the memory further stores at least one conversion coefficient; and
the first control assembly is configured to obtain the at least one conversion coefficient from the memory, and determine target compensation values for the plurality of sub-pixels at other specified luminance except the first specified luminance based on the at least one conversion coefficient and the target compensation values for the plurality of sub-pixels at the first specified luminance.

In some embodiments, the memory stores seven conversion coefficients; and
the first control assembly is configured to obtain the seven conversion coefficients from the memory, and determine target compensation values for the plurality of sub-pixels at other seven kinds of specified luminance except the first specified luminance based on the seven conversion coefficients and the target compensation values for the plurality of sub-pixels at the first specified luminance; and the first specified luminance and the seven kinds of specified luminance are uniformly distributed in a luminance range of the display panel.

In some embodiments, the target compensation values for the plurality of sub-pixels are compensation values corresponding to display devices of same manufacturing lot having the target circuit structure.

According to some embodiments of the present disclosure, a compensation system of a display device is provided. The compensation system includes a display device and a compensation device, wherein
the display device includes a display panel, a first control assembly, and a memory, wherein the display panel includes a substrate, and a target circuit structure and a plurality of light-emitting units which are disposed on the substrate, wherein the substrate is provided with a second display region and a first display region outside the second display region; the plurality of light-emitting units are disposed in both the second display region and the first display region; and the target circuit structure is electrically connected to the plurality of light-emitting units; and
the compensation device is configured to:
obtain temporary compensation values for a plurality of sub-pixels in the second display region at first specified luminance based on a compensation value determination process;
add the temporary compensation values for the plurality of sub-pixels in the second display region to candidate compensation values for the plurality of sub-pixels in the second display region;
compensate for the plurality of sub-pixels in the second display region with the candidate compensation values for the plurality of sub-pixels;
determine whether a luminance difference between the second display region and the first display region conforms to target luminance data;
execute a step of obtaining the temporary compensation values for the plurality of sub-pixels in the second display region at the first specified luminance based on the compensation value determination process in a case that the luminance difference does not conform to the target luminance data;
determine the candidate compensation values for the plurality of sub-pixels as target compensation values for the plurality of sub-pixels at the first specified luminance in a case that the luminance difference conforms to the target luminance data; and
store the target compensation values for the plurality of sub-pixels at the first specified luminance into the memory of the display device, wherein the compensation value determination process includes:
compensating for the plurality of sub-pixels with the candidate compensation values for the plurality of sub-pixels and controlling the display panel to display image data of the first specified luminance;
obtaining luminance parameters of the plurality of sub-pixels in the second display region and a luminance parameter of the first display region; and
determining the temporary compensation values based on difference values between the luminance parameters of the plurality of sub-pixels and the luminance parameter of the first display region.

In some embodiments, the compensation device includes a second control assembly and an image acquisition assembly, wherein
the image acquisition assembly is configured to:
acquire images of the plurality of sub-pixels in the second display region and an image of the first display region in a case that the display panel displays the image data of the first specified luminance; and
the second control assembly is configured to:
determine the luminance parameters of the plurality of sub-pixels based on the images of the plurality of sub-pixels in the second display region; and
determine the luminance parameter of the first display region based on the image in the first display region.

In some embodiments, the image acquisition assembly is configured to:
shoot an image in the second display region and in at least part of the first display region surrounding the second display region in a case that the display panel displays the image data of the first specified luminance.

In some embodiments, the second control assembly is configured to:
determine a luminance mean of the first display region based on the image in the first display region; and
determine the luminance parameter of the first display region based on the luminance mean.

In some embodiments, the compensation device is configured to:
obtain conversion coefficients between the target compensation values of the plurality of sub-pixels at the first specified luminance and other target compensation values, wherein the other target compensation values are target compensation values for the plurality of sub-pixels at specified luminance except the first specified luminance; and
store the conversion coefficients into the memory of the display device.

In some embodiments, the second control assembly is configured to:
determine the temporary compensation values according to a preset formula, the preset formula including:

$$pD 1 = lv {1}_{t}^{\frac{1}{g}} - lv {1}_{p}^{\frac{1}{g}} ,$$

where pD1 is a temporary compensation value for a first sub-pixel in the plurality of sub-pixels, lv1ₜ is a luminance parameter of the first display region, lv1ₚ is a luminance parameter of the first sub-pixel, and g is a gamma value of the display device.

In some embodiments, the plurality of light-emitting units includes at least a blue light-emitting unit for emitting blue light, a green light-emitting unit for emitting green light, and a red light-emitting unit for emitting red light; and
the target compensation values include a blue light compensation value for the blue light-emitting unit, a green light compensation value for the green light-emitting unit and a red light compensation value for the red light-emitting unit.

According to still another aspect of the embodiments of the present disclosure, a method for determining compensation values is provided. The method for determining compensation values is applicable to a compensation system of a display device. The compensation system includes a display device and a compensation device, wherein the compensation device is configured to compensate for the display device; and the display device includes a display panel, a first control assembly and a memory, wherein the display panel includes a substrate, and a target circuit structure and a plurality of light-emitting units which are disposed on the substrate, wherein the substrate is provided with a second display region and a first display region outside the second display region; the plurality of light-emitting units are disposed in both the second display region and the first display region; and the target circuit structure is electrically connected to the plurality of light-emitting units; and the method includes:
obtaining temporary compensation values for a plurality of sub-pixels in the second display region at first specified luminance based on a compensation value determination process;
adding the temporary compensation values for the plurality of sub-pixels to candidate compensation values for the plurality of sub-pixels;
compensating for the plurality of sub-pixels with the candidate compensation values for the plurality of sub-pixels;
determining whether a luminance difference between the second display region and the first display region conforms to target luminance data;
executing the step of obtaining the temporary compensation values for the plurality of sub-pixels in the second display region at the first specified luminance based on the compensation value determination process in a case that the luminance difference does not conform to the target luminance data; and
determining the candidate compensation values for the plurality of sub-pixels as target compensation values for the plurality of sub-pixels at the first specified luminance in a case that the luminance difference conforms to the target luminance data, wherein
the compensation value determination process includes:
compensating for the plurality of sub-pixels with the candidate compensation values for the plurality of sub-pixels and controlling the display panel to display image data of the first specified luminance;
obtaining luminance parameters of the plurality of sub-pixels in the second display region and a luminance parameter of the first display region; and
determining the temporary compensation values based on difference values between the luminance parameters of the plurality of sub-pixels and the luminance parameter of the first display region.

In some embodiments, obtaining the luminance parameters of the plurality of sub-pixels in the second display region and the luminance parameter of the first display region includes: acquiring images of the plurality of sub-pixels in the second display region and an image
in the first display region in a case that the display panel displays the image data of the first specified luminance;
determining the luminance parameters of the plurality of sub-pixels based on the images of the plurality of sub-pixels in the second display region; and
determining the luminance parameter of the first display region based on the image in the first display region.

In some embodiments, the method further includes:
obtaining conversion coefficients between the target compensation values for the plurality of sub-pixels at the first specified luminance and other target compensation values, wherein the other target compensation values are target compensation values for the plurality of sub-pixels at specified luminance except the first specified luminance; and
storing the conversion coefficients into the memory of the display device.

In some embodiments, determining the temporary compensation values based on the difference values between the luminance parameters of the plurality of sub-pixels and the luminance parameter of the first display region includes:
determining the temporary compensation values according to a preset formula, the preset formula including:

$$pD 1 = lv {1}_{t}^{\frac{1}{g}} - lv {1}_{p}^{\frac{1}{g}} ,$$

where pD1 is a temporary compensation values for a first sub-pixel in the plurality of sub-pixels, lv1ₜ is the luminance parameter of the first display region, lv1ₚ is a luminance parameter of the first sub-pixel, and g is a gamma value of the display device.

A computer program product or a computer program is provided. The computer program product or the computer program includes a computer instruction which is stored in a computer-readable storage medium. A processor of a computer device reads the computer instruction from the computer-readable storage medium, and executes the computer instruction, such that the computer device executes the method for determining the compensation values provided by the above various alternative embodiments.

### BRIEF DESCRIPTION OF DRAWINGS

For clearer descriptions of the technical solutions in embodiments of the present disclosure, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a display device according to some embodiments of the present disclosure;

FIG. 2 is an enlarged schematic structural diagram of a partial region of a display panel in the display device shown in FIG. 1;

FIG. 3 is a connection circuit diagram of a light-emitting unit and a pixel circuit in a second display region in the display panel shown in FIG. 2;

FIG. 4 is a schematic diagram showing that the luminance of the light-emitting units in the second display region in the display panel is affected by neighboring pixels;

FIG. 5 is a structural block diagram of a compensation system of a display device according to some embodiments of the present disclosure;

FIG. 6 is a method flowchart of a method for determining compensation values according to some embodiments of the present disclosure;

FIG. 7 shows a schematic flowchart of a compensation value determination process in the embodiment shown in FIG. 6;

FIG. 8 is a method flowchart of another method for determining compensation values according to some embodiments of the present disclosure;

FIG. 9 is a schematic diagram of a compensation effect of a luminance curve based on the method according to some embodiments of the present disclosure; and

FIG. 10 is a schematic diagram of a compensation effect based on the method according to some embodiments of the present disclosure.

Specific embodiments of the present disclosure are shown through the above accompanying drawings and are descried in more detail below. These accompanying drawings and text description explains the concept of the present disclosure for a person skilled in the art with reference to specific embodiments, rather than limiting the scope of the concept of the present disclosure in any manner.

### DETAILED DESCRIPTION

For clearer descriptions of the objectives, technical solutions and advantages in the present disclosure, the embodiments of the present disclosure are described in detail hereinafter with reference to the accompanying drawings.

The display device includes a display panel including a full display with camera (FDC) region and a conventional display region outside the FDC region. The FDC region has a light-transmitting function and then a camera is disposed at a position, corresponding to the FDC region, of the back surface of the display panel, so that an FDC function is achieved. Some circuit structures corresponding to the FDC region are disposed in the conventional display region to improve the light transmittance of the FDC region.

However, due to special circuit structures corresponding to the FDC region, a luminance difference between the FDC region and the conventional display region is great, resulting in the poor display effect of the display device.

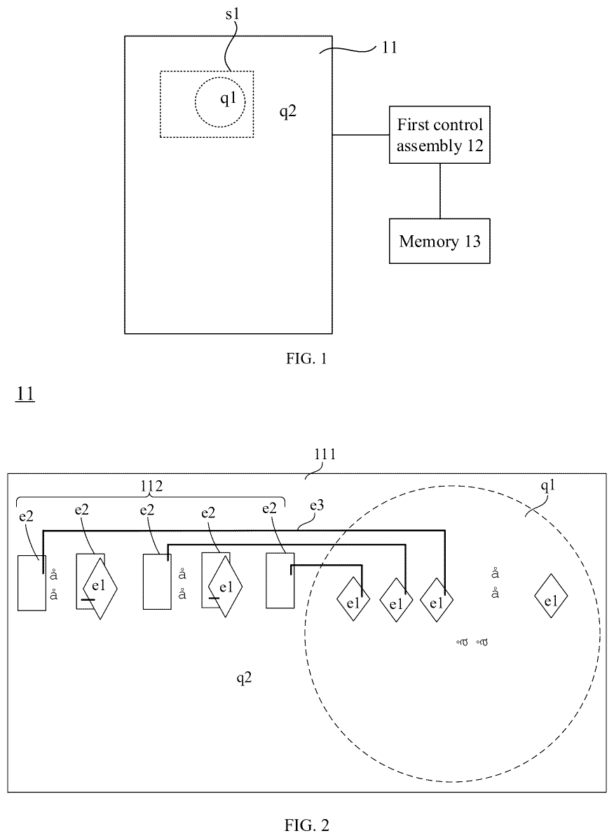

FIG. 1 is a schematic structural diagram of a display device according to some embodiments of the present disclosure and FIG. 2 is an enlarged schematic structural diagram of a partial region of a display panel in the display device shown in FIG. 1 (FIG. 2 is an enlarged schematic structural diagram of a region s1 in FIG. 1). Referring to FIG. 1 and FIG. 2, the display device includes a display panel 11, a first control assembly 12 and a memory 13. The display panel 11 includes a substrate 111, and a target circuit structure 112 and a plurality of light-emitting units e1 which are disposed on the substrate 111. The substrate 111 is provided with a second display region q1 and a first display region q2 outside the second display region q1; the plurality of light-emitting units e1 are disposed in both the second display region q1 and the first display region q2; and the target circuit structure 112 is electrically connected to the plurality of light-emitting units e1.

The memory 13 stores target compensation values for a plurality of sub-pixels in the second display region q1, and the target compensation values for the plurality of sub-pixels are compensation values corresponding to the target circuit structure 112.

The first control assembly 12 is configured to obtain the target compensation values for the plurality of sub-pixels from the memory 13 and compensate for the plurality of sub-pixels in the second display region based on the target compensation values for the plurality of sub-pixels.

The target compensation values for the plurality of sub-pixels include target compensation values for the plurality of sub-pixels at first specified luminance, and the target compensation values at the first specified luminance are configured to make a luminance difference between the plurality of sub-pixels in the second display region and sub-pixels in the first display region conform to target luminance data upon compensating for the plurality of sub-pixels in the second display region.

In summary, according to the display device provided by the embodiments of the present disclosure, the memory of the display device stores the target compensation values for the plurality of sub-pixels in the second display region, the target compensation values for the plurality of sub-pixels are the compensation values corresponding to the target circuit structure, and then a first controller compensates for the plurality of sub-pixels in the second display region based on the target compensation values, such that the luminance difference between the plurality of sub-pixels in the second display region and the sub-pixels in the first display region conforms to the target luminance data. In this way, the problem of the poor display effect of the display device caused by the great luminance difference between the sub-pixels in the second display region and the sub-pixels in the first display region in the related art is solved, thereby improving the display effect of the display device.

In addition, a compensation scheme in the related art compensates for display differences due to individual differences of various display devices, and thus the compensation value is not universal across different display devices. However, in the display device provided by the embodiments of the present disclosure, as the luminance difference compensated for in the second display region is caused by some circuit structures corresponding to the second display region, the target compensation values stored in the memory are applied to display devices having the same target circuit structure. Thus, there is no need to determine separately a target compensation value for each display device, thereby reducing the difficulty in debugging the display devices and increasing the production speeds of the display device.

It should be noted that the display panel includes a plurality of sub-pixels arranged in an array. Each sub-pixel includes a light-emitting unit and a pixel circuit electrically connected to the light-emitting unit. The first control assembly 12 compensates for the sub-pixels based on the target compensation values to adjust the luminance of the light-emitting units in the sub-pixels.

In addition, the target circuit structure 112 refers to some or all of circuits included in the display panel 11 and includes a pixel circuit e2 corresponding to each sub-pixel.

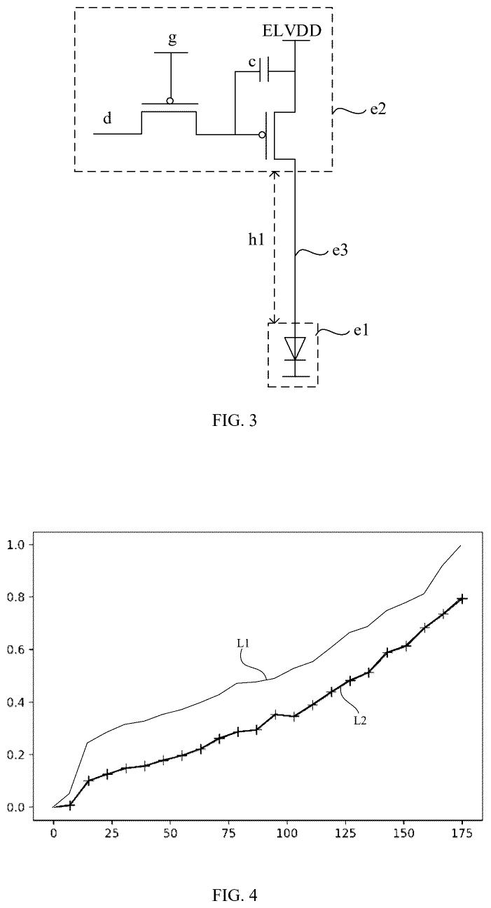

For a display panel using a FDC technology, in order to improve the light transmittance of the second display region, pixel circuits of sub-pixels corresponding to the second display region are disposed in the first display region, and the pixel circuits and light-emitting units are connected by wiring. FIG. 3 is a connection circuit diagram of a light-emitting unit and a pixel circuit in the second display region in the display panel shown in FIG. 2. Referring to FIG. 2 and FIG. 3, the pixel circuit e2 includes structures such as a data line d, a gate g, a capacitor c, and a power supply line ELVDD, and the light-emitting unit e1 is electrically connected to the pixel circuit e2 via a connecting line e3, wherein h1 is an extension of the connecting line e3 caused by the fact that the pixel circuit e2 is disposed in the first display region q2.

The applicant has found that such a scheme increases the length of the connecting line between the pixel circuit and the light-emitting unit, which in turn leads to a relatively great difference between the luminance of the light-emitting unit in the second display region and the luminance of the light-emitting unit in the first display region.

In addition, the applicant has found that the luminance of the light-emitting unit in the second display region is affected by the grayscale of its neighboring pixels, and this phenomenon is called the “neighborhood effect”. Specifically, in the second display region, a calculation formula of the luminance lv_{xy} of the sub-pixel xy is:

$${lv}_{xy} = {f}_{xy} ( {g}_{xy} ) + {\sum }_{p}^{p ∈ n} {h}_{p} ( xy , {g}_{p} , {g}_{xy} ) ,$$

wherein lv_{xy} is actual luminance of the sub-pixel xy obtained by shooting, f_{xy}( . . . ) is an influence function of grayscale of the sub-pixel xy on its own luminance, g_{xy} is the grayscale of the sub-pixel xy, xy is coordinates of the sub-pixel xy, gₚ is grayscale of the neighboring sub-pixel, hₚ( . . . ) is an influence function of the neighboring sub-pixel p of the sub-pixel xy on the sub-pixel xy, the result of the hₚ( . . . ) is influenced by the coordinates xy of the sub-pixel xy, gₚ and g_{xy}, n denotes all neighboring pixels and

$${\sum }_{p}^{p ∈ n} {h}_{p} ( xy , {g}_{p} , {g}_{xy} )$$

denotes a sum of influence functions of all the neighboring sub-pixels p on the sub-pixel xy.

The calculation formula reflects that the pixel xy is affected by its own grayscale as well as the grayscale of its neighboring pixels.

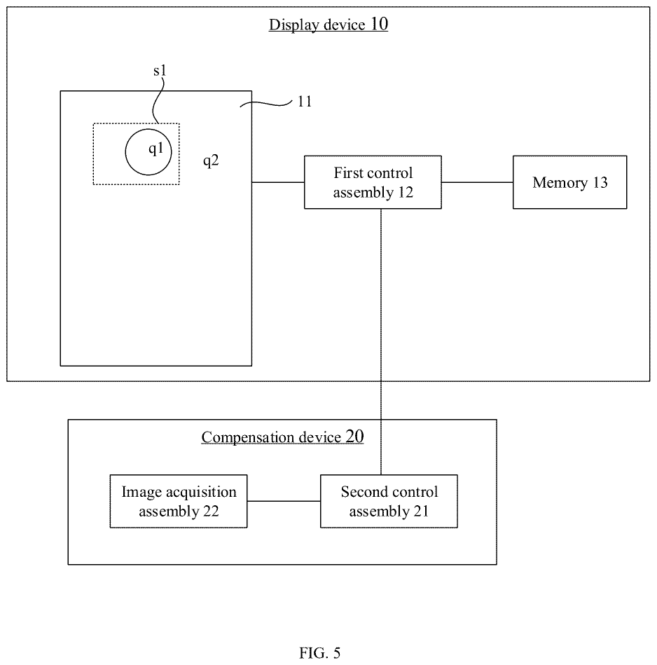

Referring to FIG. 4, FIG. 4 is a schematic diagram shows that the luminance of the light-emitting units in the second display region in the display panel is affected by neighboring pixels, wherein a curve L1 is a luminance curve of a light-emitting unit 1 in the second display region when its own grayscale is 63, a curve L2 is a luminance curve of the light-emitting unit 1 in the second display region when its own grayscale is 47, the transverse axis denotes grayscale values of a plurality of light-emitting units neighboring the light-emitting unit 1, and the longitudinal axis denotes the actual luminance of the light-emitting unit 1 in nits. It can be seen that the grayscale values of the plurality of light-emitting units neighboring the light-emitting unit 1 have a significant effect on the actual luminance of the light-emitting unit 1.

One reason for this is electric leakage among adjacent pixels, which causes the luminous characteristics of the pixels in the second display region are seriously affected by the luminous characteristics of the neighboring pixels, and it is difficult to measure and formulize the degree of influence. As a result, it is difficult to achieve an expected effect when a conventional compensation method is used to compensate for image quality in the second display region as it is difficult to eliminate this influence.

For the above problem, the embodiments of the present disclosure provide a display device, the memory of the display device stores the target compensation values for the plurality of sub-pixels in the second display region, the target compensation values for the plurality of sub-pixels are the compensation values corresponding to the target circuit structure, and then a first controller compensates for the plurality of sub-pixels in the second display region based on the target compensation values, such that the luminance difference between the plurality of sub-pixels in the second display region and the sub-pixels in the first display region conforms to the target luminance data. In this way, the problem of the poor display effect of the display device caused by the great luminance difference between the sub-pixels in the second display region and the sub-pixels in the first display region in the related art is solved, thereby improving the display effect of the display device.

It should be noted that in the display device provided by the embodiments of the present disclosure, the second display region in the display panel is a display region having a light-transmitting function, and the display device includes one or more sensors which are disposed at a position, opposite to the second display region, outside a back surface of the display panel (the display panel is provided with a display surface and a back surface opposite to the display surface). The sensors include an image sensor, an ambient light sensor, a distance sensor, an infrared sensor, etc. In some embodiments, when the sensors include the image sensor (such as a camera), the second display region is an FDC region.

In some embodiments, in the display device provided by the embodiments of the present disclosure, the memory 13 further stores at least one conversion coefficient.

Referring to FIG. 1, the first control assembly 12 is configured to obtain the at least one conversion coefficient from the memory 13, and determine target compensation values for the plurality of sub-pixels at other specified luminance except the first specified luminance based on the at least one conversion coefficient and the target compensation values for the plurality of sub-pixels at the first specified luminance.

In this way, the first control assembly 12 obtains the target compensation values for the plurality of sub-pixels in the second display region at other specified luminance based on the target compensation values for the plurality of sub-pixels in the second display region at the first specified luminance and the conversion coefficient and then compensate for the plurality of sub-pixels in the second display region at the other specified luminance. In addition, the first specified luminance may refer not to the actual luminance of the sub-pixel, but to the ideal luminance of the sub-pixel, which is determined by the luminance of image data corresponding to the sub-pixel. For example, the target compensation value at the first specified luminance is configured to compensate for the sub-pixel when the luminance of the image data corresponding to the sub-pixel is the first specified luminance.

The second display region has a large number of sub-pixels, and the data amount of the target compensation value for each of these sub-pixels is large, and the data amount of the conversion coefficient is less than the sum of data amounts of the target compensation values for the plurality of sub-pixels in the second display region at one kind of specified luminance. Thus, compared with the mode of storing the target compensation values for the plurality of sub-pixels in the second display region, the mode of storing the conversion coefficient provided by the embodiments of the present disclosure reduces the occupation of the space of the memory 13.

It should be noted that the plurality of sub-pixels in the second display region involved in the embodiments of the present disclosure refers to part or all of the sub-pixels in the second display region.

In addition, due to the design of circuits in the second display region, there may be a case where a light-emitting unit is disposed in the second display region, but a corresponding pixel circuit is disposed in the first display region. For this, it is possible to confirm whether the sub-pixel is a sub-pixel in the second display region or a sub-pixel in the first display region based on the position of the light-emitting unit, that is, the sub-pixel is in the second display region in the case that the light-emitting unit in this sub-pixel is disposed in the second display region; and the sub-pixel is in the first display region in the case that the light-emitting unit in this sub-pixel is disposed in the first display region.

In addition, in the display device provided by the embodiments of the present disclosure, the target compensation values for the plurality of sub-pixels at the first specified luminance, which are stored in the memory 13, are also configured to compensate for pixels where the various sub-pixels are disposed. In some embodiments, a plurality of pixels are included in the second display region, each pixel includes multiple kinds of sub-pixels, which include, for example, a blue sub-pixel for emitting blue light, a sub-pixel for emitting green light, and a sub-pixel for emitting red light, and the memory 13 stores the target compensation values for the plurality of sub-pixels at the first specified luminance. The various sub-pixels belong to different pixels respectively, and the first control assembly compensates for the various pixels based on the target compensation values for the plurality of sub-pixels at the first specified luminance. In this way, the effect of reducing the occupation of the space of the memory 13 in the display device can be achieved.

Certainly, the memory 13 also stores the target compensation value for each sub-pixel in the second display region at the first specified luminance, that is, sub-pixels of different colors in each pixel have different target compensation values, such that the sub-pixels of different colors may be compensated for based on the different colors. In this way, the compensation effect for the second display region is improved and thus the display effect of the display device is improved.

In some embodiments, the memory 13 stores seven conversion coefficients.

The first control assembly is configured to obtain the seven conversion coefficients from the memory 13, and determine target compensation values for the plurality of sub-pixels at other seven kinds of luminance except the first specified luminance based on the seven conversion coefficients and the target compensation values for the plurality of sub-pixels at the first specified luminance. The first specified luminance and the seven kinds of specified luminance are uniformly distributed in the luminance range of the display panel.

This scheme is a specific compensation scheme, the first control assembly obtains the target compensation values for the plurality of sub-pixels in the second display region at the seven kinds of specified luminance based on the seven conversion coefficients and the target compensation values for the plurality of sub-pixels at the first specified luminance; these target compensation values at the seven kinds of specified luminance and the target compensation values at the first specified luminance are the target compensation values at the eight kinds of specified luminance; and these eight kinds of specified luminance are uniformly distributed in the luminance range of the display panel. In this way, the compensation effect of the second display region is ensured while the occupation of the space of the memory by the targe compensation values is reduced.

In some embodiments, if the luminance is expressed with a grayscale value and the luminance range of the display panel is 0-255, with the grayscale value of 0 being the darkest, and the grayscale value of 255 being the brightest, the eight kinds of specified luminance are eight kinds of specified luminance uniformly distributed in the range of 0 to 255, for example, one grayscale value is determined as the specified luminance for every 32 grayscales.

In some embodiments, the target compensation values at the above eight kinds of specified luminance correspond to eight sub-ranges in the luminance range of the display panel respectively. These eight sub-ranges are eight sub-ranges divided equally from 0-255, for example, these eight sub-ranges may include eight sub-ranges 0-31, 32-63, 64-95, 96-127, 128-159, 160-191, 192-223 and 224-255, and the eight kinds of specified luminance are grayscale values of the eight sub-ranges respectively and the specified luminance corresponds to the sub-range to which the specified luminance belongs. In an example, when a grayscale value of a first sub-pixel in the second display region (the first sub-pixel is any sub-pixel in the second display region) is a first grayscale value (the first grayscale value is determined by image data to be displayed), the first control assembly determines the sub-range to which the first grayscale value belongs, and compensates for the first sub-pixel based on the target compensation value corresponding to the sub-range to which the first grayscale value belongs.

In some embodiments, since circuit structures in the display devices manufactured in different manufacturing lots may be the same, some other factors may result in differences in the compensation effect of the same compensation value for sub-pixels in the second display regions of the display devices of different manufacturing lots. The target compensation values for the plurality of sub-pixels, which are stored in the memory 13, are the compensation values corresponding to the display devices of the same manufacturing lot having the target circuit structure. That is, the same target compensation values are stored in the memories of the display devices of a manufacturing lot (the compensation values here may include the target compensation values for each sub-pixel in the second display region at multiple kinds of specified luminance).

In summary, according to the display device provided by the embodiments of the present disclosure, the memory of the display device stores the target compensation values for the plurality of sub-pixels in the second display region, the target compensation values for the plurality of sub-pixels are the compensation values corresponding to the target circuit structure, and then a first controller compensates for the plurality of sub-pixels in the second display region based on the target compensation values, such that the luminance difference between the plurality of sub-pixels in the second display region and the sub-pixels in the first display region conforms to the target luminance data. In this way, the problem of the poor display effect of the display device caused by the great luminance difference between the sub-pixels in the second display region and the sub-pixels in the first display region in the related art is solved. Therefore, the display effect of the display device is improved.

FIG. 5 is a structural block diagram of a compensation system of a display device according to some embodiments of the present disclosure. The compensation system includes a display device 10 and a compensation device 20.

The display device 10 is any of the display devices provided by the embodiments above and is electrically connected to the compensation device 20.

The compensation device 20 is configured to execute the following steps.

In 4.1, temporary compensation values for a plurality of sub-pixels in the second display region at the first specified luminance are obtained based on a compensation value determination process.

In 4.2, the temporary compensation values for the plurality of sub-pixels are added to candidate compensation values for the plurality of sub-pixels.

In the case where there is no temporary compensation value added to the candidate compensation values, the candidate compensation values are equal to the temporary compensation values added at this time, and in the case where there are any temporary compensation values added before this time (“times” here refers to the number of times for which the cycle of 4.1 to 4.6 is executed) in the candidate compensation values, the candidate compensation values are equal to the sum of the temporary compensation values added at this time and the temporary compensation values added to the candidate compensation values over all the times. In some embodiments, if the temporary compensation value at this time is 1 and the candidate compensation value further includes a temporary compensation value of 2 which is added to the candidate compensation value at a previous time, the candidate compensation value is 3 after the temporary compensation value at this time is added to the candidate compensation value.

In 4.3) the plurality of sub-pixels is compensated for with the candidate compensation values for the plurality of sub-pixels.

In some embodiments, the compensation device 20 notifies the display device 10 and the first control assembly in the display device 10 compensates for the plurality of sub-pixels with the candidate compensation values for the plurality of sub-pixels.

In 4.4) whether a luminance difference between the second display region and the first display region conforms to the target luminance data is determined.

After the plurality of sub-pixels is compensated for with the candidate compensation values for the plurality of sub-pixels, the display panel displays image data of the first specified luminance, and the compensation device 20 shoots an image of the second display region and an image of the first display region, and determine whether the luminance difference between the second display region and the first display region conforms to the target luminance data based on the shot images.

In some embodiments, the target luminance data is configured to measure a difference between the overall luminance of the second display region and the luminance of the first display region. For example, the target luminance data includes a luminance difference threshold; the compensation device 20 obtains an absolute value of a difference value between a luminance value of each sub-pixel in the second display region and a luminance value of the first display region and obtains a mean of these absolute values of all the sub-pixels in the second display region, and the mean is a comprehensive difference value. If the comprehensive difference value is less than the luminance difference threshold, it is confirmed that the luminance difference conforms to the target luminance data, and if the comprehensive difference value is not less than the luminance difference threshold, it is confirmed that the luminance difference does not conform to the target luminance data.

Certainly, it is also possible to determine whether the luminance difference conforms to the target luminance data in other modes, which is not limited in the embodiments of the present disclosure.

In 4.5) the step of obtaining the temporary compensation values for the plurality of sub-pixels in the second display region at the first specified luminance based on the compensation value determination process is executed in the case where the luminance difference does not conform to the target luminance data.

That is, step 4.1 above is re-executed in the case where the luminance difference does not conform to the target luminance data.

In 4.6) the candidate compensation values for the plurality of sub-pixels are determined as target compensation values for the plurality of sub-pixels at the first specified luminance in the case where the luminance difference conforms to the target luminance data.

In 4.7) the target compensation values for the plurality of sub-pixels at the first specified luminance are stored into the memory of the display device.

The compensation value determination process includes the following steps.

In 4.11) the plurality of sub-pixels is compensated for with the candidate compensation values for the plurality of sub-pixels and the display panel is controlled to display image data of the first specified luminance, wherein

the candidate compensation value includes a preset initial value when this is the first time the compensation value is determined through the compensation value determination process.

In 4.12) luminance parameters of the plurality of sub-pixels in the second display region and a luminance parameter of the first display region are obtained.

In 4.13) the temporary compensation values are determined based on difference values between the luminance parameters of the plurality of sub-pixels and the luminance parameter of the first display region.

Step 4.1 to step 4.4 above are one compensation value determination cycle, the compensation effect of the candidate compensation values are improved after each cycle, and when the above luminance difference conforms to the target luminance data, the cycle is stopped and the candidate compensation values are determined as the target compensation values for the plurality of sub-pixels at the first specified luminance.

In summary, according to the compensation system of the display device provided by the embodiments of the present disclosure, the memory of the display device stores the target compensation values for the plurality of sub-pixels in the second display region, the target compensation values for the plurality of sub-pixels are the compensation values corresponding to the target circuit structure, and then a first controller compensates for the plurality of sub-pixels in the second display region based on the target compensation values, so that the luminance difference between the plurality of sub-pixels in the second display region and the sub-pixels in the first display region conforms to the target luminance data. In this way, the problem of the poor display effect of the display device caused by the great luminance difference between the sub-pixels in the second display region and the sub-pixels in the first display region in the related art can be solved. Therefore, the display effect of the display device is improved.

In some embodiments, the compensation device 20 includes a second control assembly 21 and an image acquisition assembly 22.

The image acquisition assembly 22 is configured to:
acquire images of the plurality of sub-pixels in the second display region q1 and acquire an image in the first display region while the display panel 11 displays the image data of the first specified luminance.

The image acquisition assembly 22 includes a camera, and by means of the camera, the second display region q1 is shot to acquire the images of the plurality of sub-pixels in the second display region q1, and the first display region q2 is shot to acquire the image in the first display region q2.

The second control assembly 21 is configured to execute the following steps.

In 5.1) the luminance parameters of the plurality of sub-pixels are determined based on the images of the plurality of sub-pixels in the second display region q1.

The luminance parameters of the plurality of sub-pixels include a luminance parameter of each of the plurality of sub-pixels in the second display region q1. The luminance parameter is a parameter that reflects the luminance of the sub-pixel, e.g., the luminance parameter is a product of a luminance value in nits and a preset parameter.

In 5.2) the luminance parameter of the first display region is determined based on the image of the first display region.

The luminance parameter of the first display region is a mean of luminance parameters of a plurality of sub-pixels in the first display region.

In some embodiments, the image acquisition assembly 22 is configured to:

shoot an image in the second display region q1 and in at least part of the first display region q2 surrounding the second display region q1 (in some embodiments, the ring width of the part of the ring-shaped first display region q2 surrounding the second display region q1 is 15 pixels) while the display panel 11 displays the image data of the first specified luminance.

Specifically, the camera of the image acquisition assembly 22 is aimed at the second display region q1, and the range of the image shot by the camera is adjusted (e.g., by adjusting the focal length of the camera or the distance between the camera and the display panel), such that the image includes the second display region q1 and part of the first display region q2 surrounding the second display region q1. In this way, the images of the second display region q1 and the first display region q2 are obtained simultaneously by a single shot, which speeds up the efficiency of implementing the scheme.

In some embodiments, the second control assembly 21 is configured to:

6.1) determine a luminance mean of the first display region based on the image in the first display region, wherein
the luminance mean is an arithmetic mean, a geometric mean, a quadratic mean, etc. of the luminance, which is not limited by the embodiments of the present disclosure; and
6.2) determine the luminance parameter of the first display region based on the luminance mean.

The second control assembly 21 determines a product of the luminance mean and the preset parameter as the luminance parameter of the first display region.

In some embodiments, the compensation device 20 is configured to execute the following steps.

In 7.1) A conversion coefficient between the target compensation values for the plurality of sub-pixels at the first specified luminance and at least one kind of other target compensation values is obtained, wherein the other target compensation values are target compensation values for the plurality of sub-pixels at specified luminance except the first specified luminance.

The compensation device obtains at least one kind of other target compensation values based on the method of obtaining the target compensation values at the first specified luminance, and determines the conversion coefficient between at least one kind of other target compensation values and the target compensation values for the plurality of sub-pixels at the first specified luminance based on at least one kind of other target compensation values and the target compensation values for the plurality of sub-pixels at the first specified luminance. In this way, the occupation of the storage space of the memory in the display device can be reduced.

In 7.2) the conversion coefficient is stored in the memory of the display device.

In some embodiments, the second control assembly 21 is configured to:
determine the temporary compensation values according to a preset formula, the preset formula including:

$$pD 1 = lv {1}_{t}^{\frac{1}{g}} - lv {1}_{p}^{\frac{1}{g}} ,$$

wherein pD1 is a temporary compensation value for a first sub-pixel in the plurality of sub-pixels, lv1ₜ is the luminance parameter of the first display region, lv1ₚ is a luminance parameter of the first sub-pixel, and g is a gamma value of the display device. The gamma value is a parameter of the display device, for example, it may be 2.2. The luminance parameter is a parameter that reflects the luminance of the sub-pixel, e.g., the luminance parameter is a product of a luminance value in nits and a preset parameter.

In some embodiments, the plurality of light-emitting units includes at least a blue light-emitting unit for emitting blue light, a green light-emitting unit for emitting green light, and a red light-emitting unit for emitting red light.

The above target compensation values include a blue light compensation value for the blue light-emitting unit, a green light compensation value for the green light-emitting unit and a red light compensation value for the red light-emitting unit. In this way, by compensating for the red light-emitting unit, the green light-emitting unit and the blue light-emitting unit respectively, the compensation effect is improved and thus the display effect of the display device can be improved.

In summary, according to the compensation system of the display device provided by the embodiments of the present disclosure, the memory of the display device stores the target compensation values for the plurality of sub-pixels in the second display region, the target compensation values for the plurality of sub-pixels are the compensation values corresponding to the target circuit structure, and then a first controller compensates for the plurality of sub-pixels in the second display region based on the target compensation values, such that the luminance difference between the plurality of sub-pixels in the second display region and the sub-pixels in the first display region conforms to the target luminance data. In this way, the problem of the poor display effect of the display device caused by the great luminance difference between the sub-pixels in the second display region and the sub-pixels in the first display region in the related art is solved, thereby improving the display effect of the display device.

The following are method embodiments of the present disclosure, and content which is not described in the method embodiments may refer to the above device embodiments of the present disclosure. Correspondingly, content which is not described in the device embodiments may refer to the following method embodiments.

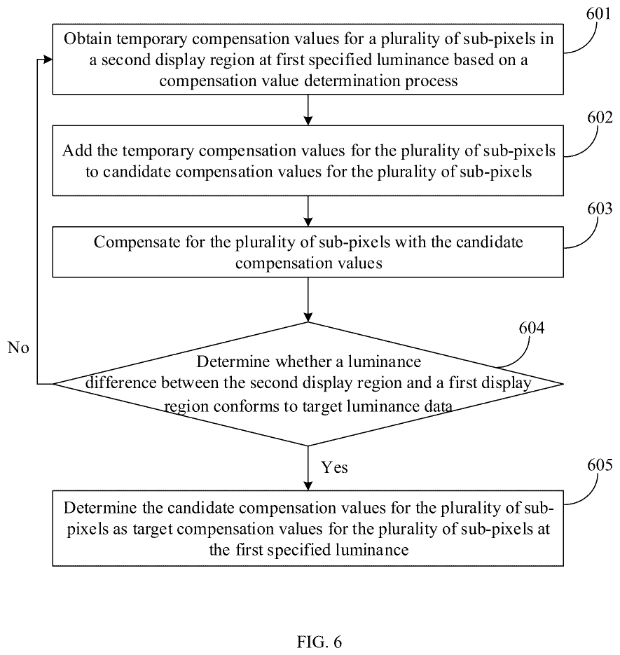

FIG. 6 is a method flowchart of a method for determining compensation values according to some embodiments of the present disclosure. The method may be applicable to the compensation system of the display device provided by the embodiments above. The method may include the following steps:
step 601, obtaining temporary compensation values for a plurality of sub-pixels in a second display region at first specified luminance based on a compensation value determination process;
step 602, adding the temporary compensation values for the plurality of sub-pixels to candidate compensation values for the plurality of sub-pixels;
step 603, compensating for the plurality of sub-pixels with the candidate compensation values;
step 604, determining whether a luminance difference between the second display region and a first display region conforms to target luminance data, if not, executing step 601, and if so, executing step 605; and
step 605, determining the candidate compensation values for the plurality of sub-pixels as target compensation values for the plurality of sub-pixels at the first specified luminance.

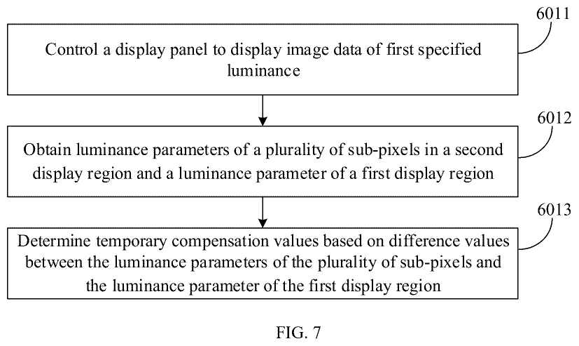

Referring to FIG. 7, FIG. 7 shows a schematic flowchart of a compensation value determination process in the embodiment shown in FIG. 6. The compensation value determination process includes:
step 6011, controlling the display panel to display image data of the first specified luminance;
step 6012, obtaining luminance parameters of a plurality of sub-pixels in the second display region and a luminance parameter of the first display region; and
step 6013, determining the temporary compensation values based on difference values between the luminance parameters of the plurality of sub-pixels and the luminance parameter of the first display region.

In summary, according to the method for determining compensation values of the display device provided by the embodiments of the present disclosure, by determining the compensation values by cycling for a plurality of times, the compensation effect of the compensation values for the plurality of sub-pixels in the second display region is enhanced, so that the determined target compensation values make the luminance difference between the second display region and the first display region conform to the target luminance data. In this way, the problem of a relatively poor display effect of the display device caused by a relatively great luminance difference between the sub-pixels in the second display region and the sub-pixels in the first display region in the related art is solved, thereby improving the display effect of the display device.

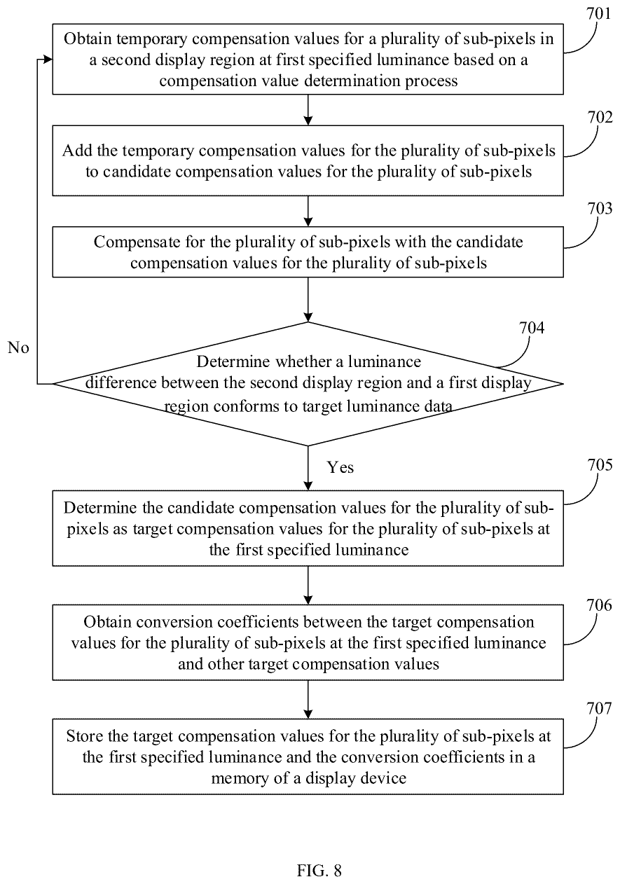

FIG. 8 is a method flowchart of another method for determining compensation values according to some embodiments of the present disclosure. The method is applicable to the compensation system of the display device provided by the embodiments above. The method includes the following steps.

In step 701, temporary compensation values for a plurality of sub-pixels in the second display region at the first specified luminance are obtained based on a compensation value determination process.

When the method provided by the embodiments of the present disclosure is applied, the compensation device in the compensation system of the display device obtains the temporary compensation values for the plurality of sub-pixels in the second display region at the first specified luminance based on the compensation value determination process. The first specified luminance is the preset luminance within the luminance range of the display panel of the display device.

The compensation value determination process includes the following steps.

In 8.1, the display panel is controlled to display image data of the first specified luminance.

The first control assembly in the display device controls the display panel to display the image data of the first specified luminance. For example, the display panel is controlled to display a solid-color picture of the first specified luminance.

In 8.2, the luminance parameters of the plurality of sub-pixels in the second display region and a luminance parameter of the first display region are obtained.

The compensation device obtains the luminance parameters of the plurality of sub-pixels in the second display region and the luminance parameter of the first display region when the display panel displays the image data of the first specified luminance.

In some embodiments, step 8.2) included the following steps.

In 8.21, images of the plurality of sub-pixels in the second display region and an image in the first display region are acquired when the display panel displays the image data of the first specified luminance.

The compensation device acquires the images of the plurality of sub-pixels in the second display region and the image in the first display region via the image acquisition assembly. In some embodiments, the compensation device aims the camera of the image acquisition assembly at the second display region, and adjusts the range of the image shot by the camera, so that the image includes the second display region and part of the first display region surrounding the second display region. In this way, the images in the second display region and the first display region are obtained simultaneously by a single shot, which speeds up the efficiency of implementing the scheme.

In 8.22, the luminance parameters of the plurality of sub-pixels are determined based on the images of the plurality of sub-pixels in the second display region.

The luminance parameters of the plurality of sub-pixels include a luminance parameter of each of the plurality of sub-pixels in the second display region. The luminance parameter reflects the luminance of the sub-pixel, e.g., the luminance parameter is a product of a luminance value in nits and a preset parameter.

In 8.23), the luminance parameter of the first display region is determined based on the image of the first display region.

The luminance mean is an arithmetic mean, a geometric mean, a quadratic mean, etc. of the luminance, which is not limited by the embodiments of the present disclosure.

In 8.3), the temporary compensation values are determined based on difference values between the luminance parameters of the plurality of sub-pixels and the luminance parameter of the first display region.

The compensation device determines the temporary compensation values based on the difference values between the luminance parameters of the plurality of sub-pixels and the luminance parameter of the first display region.

In some embodiments, the second control assembly in the compensation device determines the temporary compensation values according to a preset formula, the preset formula including:

$$pD 1 = lv {1}_{t}^{\frac{1}{g}} - lv {1}_{p}^{\frac{1}{g}} ,$$

where pD1 is a temporary compensation value for a first sub-pixel in the plurality of sub-pixels, lv1ₜ is a luminance parameter of the first display region, lv1ₚ is a luminance parameter of the first sub-pixel, and g is a gamma value of the display device. The gamma value is a parameter of the display device, for example, it is 2.2. The luminance parameter reflects the luminance of the sub-pixel, e.g., the luminance parameter is a product of a luminance value in nits and a preset parameter.

In step 702, the temporary compensation values for the plurality of sub-pixels are added to candidate compensation values for the plurality of sub-pixels.

The compensation device (the second control assembly in the compensation device) adds the temporary compensation values for the plurality of sub-pixels to candidate compensation values for the plurality of sub-pixels. In the case where there is no temporary compensation value added to the candidate compensation values, the candidate compensation values are equal to the temporary compensation values added at this time (“times” here may refer to the number of times for which the cycle of 701 to 704 is executed), and in the case where there are any temporary compensation values added before this time in the candidate compensation values, the candidate compensation values are equal to the sum of the temporary compensation values added at this time and the temporary compensation values added to the candidate compensation values over all the times. In some embodiments, if the temporary compensation value determined at this time is 1 and the candidate compensation value further includes a temporary compensation value of 2 which is added to the candidate compensation value at a previous time, the candidate compensation value is 3 after the temporary compensation value at this time is added to the candidate compensation value.

In step 703, the plurality of sub-pixels is compensated for with the candidate compensation values for the plurality of sub-pixels.

The compensation device (the second control assembly in the compensation device) controls the first control assembly in the display device to compensate for the plurality of sub-pixels with the candidate compensation values.

In step 704, whether a luminance difference between the second display region and the first display region conforms to the target luminance data is determined. If not, step 701 is executed, and if so, step 705 is executed.

In step 704, the compensation device executes the following operations.

1) The display device is controlled, so that the display panel in the display device is controlled to display image data of the first specified luminance.

For example, the second control assembly in the compensation device sends an instruction to the first control assembly in the display device, so that the first control assembly controls the display panel to display the image data of the first specified luminance.

2) Image data of the second display region and image data of the first display region are acquired via the image acquisition assembly in the compensation device.

The compensation device acquires again the image data of the first display region and image data of the second display region, which is compensated for with the candidate compensation values, via the image acquisition assembly.

3) Whether a luminance difference between the second display region and the first display region conforms to target luminance data is determined via the second control assembly in the compensation device based on the image data of the second display region and the image data of the first display region.

The target luminance data is configured to measure the difference between the overall luminance of the second display region and the luminance of the first display region. For example, the target luminance data include a luminance difference threshold; the compensation device 20 obtains an absolute value of a difference value between a luminance value of each sub-pixel in the second display region and a luminance value of the first display region and obtains a mean of these absolute values of all the sub-pixels in the second display region, and the mean may be a comprehensive difference value. If the comprehensive difference value is less than the luminance difference threshold, it is confirmed that the luminance difference conforms to the target luminance data, and if the comprehensive difference value is not less than the luminance difference threshold, it is confirmed that the luminance difference does not conform to the target luminance data.

Certainly, it is also possible to determine whether the luminance difference conforms to the target luminance data in other modes, which is not limited in the embodiments of the present disclosure.

When the luminance difference does not conform to the target luminance data, the compensation device re-executes step 701 to execute the next cycle. In this way, the compensation effect of the candidate compensation values is gradually improved by cycling for a plurality of times.

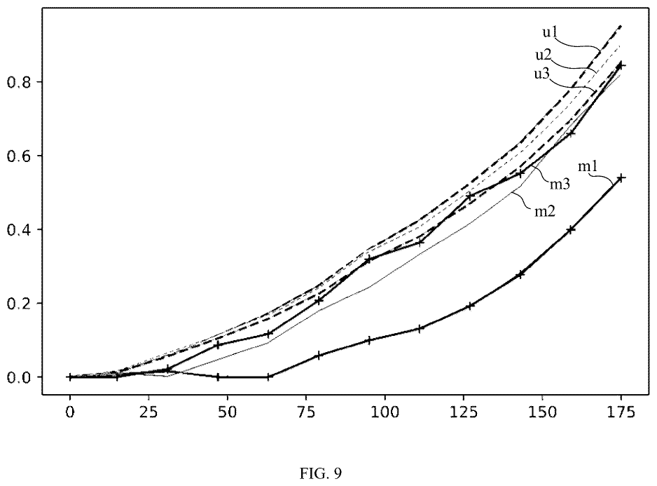

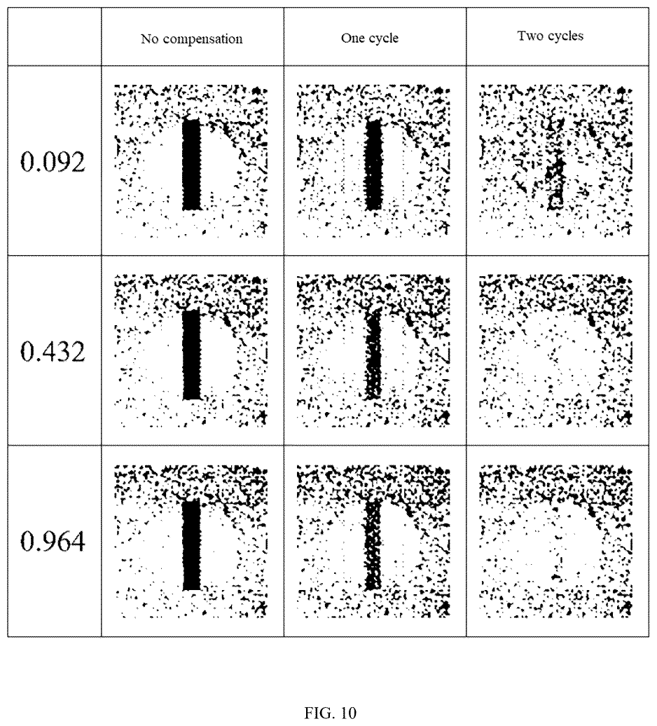

In some embodiments, referring to FIG. 9, FIG. 9 is a schematic diagram of a compensation effect of a luminance curve in the method according to some embodiments of the present disclosure. The transverse axis denotes grayscale values, the longitudinal axis denotes actual luminance values acquired via the camera in nits, the curve u1 denotes a luminance curve of the first display region which is not compensated, the curve m1 denotes a luminance curve of the second display region which is not compensated, and the luminance curve reflects actual luminance under different grayscale values.

After one cycle and compensation with the candidate compensation values, the luminance curve of the first display region is u2, and the luminance curve of the second display region is m2; after two cycles and compensation with the candidate compensation value, the luminance curve of the first display region is u3, and the luminance curve of the second display region is m3. It can be seen that at this time, the luminance curve of a curved shooting region has been very close to that of the first display region, thereby achieving a good compensation effect.

Referring to FIG. 10, FIG. 10 is a schematic diagram of a compensation effect in the method according to some embodiments of the present disclosure, wherein the first column on the left side denotes luminance values (ideal luminance values of the sub-pixels in the screen) in nits and nine pictures on the right side show compensation effects of the second display region as well as the surrounding first display region at different kinds of luminance after different cycles of compensation, and it can be seen that the luminance difference between the second display region and the surrounding first display region has been significantly reduced after two cycles at different kinds of luminance.

In step 705, the candidate compensation values for the plurality of sub-pixels are determined as target compensation values for the plurality of sub-pixels at the first specified luminance.

When the luminance difference conforms to the target luminance data, the compensation device determines the candidate compensation values for the plurality of sub-pixels as target compensation values for the plurality of sub-pixels at the first specified luminance.

In step 706, a conversion coefficient between the target compensation values for the plurality of sub-pixels at the first specified luminance and at least one kind of other target compensation values is obtained.

The other target compensation values are target compensation values for the plurality of sub-pixels at specified luminance except the first specified luminance.

The compensation device obtains the at least one kind of other target compensation values based on the method of obtaining the target compensation values at the first specified luminance, and determines the conversion coefficient between at least one kind of other target compensation values and the target compensation values at the first specified luminance based on the at least one kind of other target compensation values and the target compensation values for the plurality of sub-pixels at the first specified luminance. In this way, the occupation of the storage space of the memory in the display device is reduced.

In step 707, the target compensation values for the plurality of sub-pixels at the first specified luminance and the conversion coefficient are stored into the memory of the display device.

The compensation device stores the target compensation values for the plurality of sub-pixels at the first specified luminance and the conversion coefficient into the memory of the display device, and thus the display device obtains target compensation values for the plurality of sub-pixels at other specified luminance based on the conversion coefficient and the target compensation values for the plurality of sub-pixels at the first specified luminance to compensate for the FDC region of the display panel.

In some embodiments, the display panel of the display device at least includes a blue light-emitting unit for emitting blue light, a green light-emitting unit for emitting green light and a red light-emitting unit for emitting red light. Correspondingly, the above target compensation values includes a blue light compensation value for the blue light-emitting unit, a green light compensation value for the green light-emitting unit and a red light compensation value for the red light-emitting unit. In this way, by compensating for the red light-emitting unit, the green light-emitting unit and the blue light-emitting unit respectively, the compensation effect is improved and thus the display effect of the display device is improved.

In summary, according to the method for determining compensation values of the display device provided by the embodiments of the present disclosure, by determining the compensation values by cycling for a plurality of times, the compensation effect of the compensation values for the plurality of sub-pixels in the second display region is enhanced, so that the determined target compensation values make the luminance difference between the second display region and the first display region conform to the target luminance data. In this way, the problem of the poor display effect of the display device caused by the great luminance difference between the sub-pixels in the second display region and the sub-pixels in the first display region in the related art is solved. Therefore, the display effect of the display device is improved.

In addition, embodiments of the present disclosure further provide a computer program product or a computer program. The computer program product or the computer program includes a computer instruction which is stored in a computer-readable storage medium. A processor of a computer device reads the computer instruction from the computer-readable storage medium, and executes the computer instruction, so that the computer device executes the method for determining compensation values provided by the above alternative embodiments.

In the present disclosure, the term “at least one of A and B” merely describes an association relationship between associated objects and indicates that there are three relationships. For example, at least one of A and B indicates that there are three cases where A exists separately, A and B exist concurrently, and B exists separately. Similarly, the term “at least one of A, B and C” indicates that there are seven cases where A exists separately, B exists separately, C exists separately, A and B exist concurrently, A and C exist concurrently, C and B exist concurrently, and A, B and C exist concurrently. Similarly, the term “at least one of A, B, C and D” indicates that there are fifteen cases where A exists separately, B exists separately, C exists separately, D exists separately, A and B exist concurrently, A and C exist concurrently, A and D exist concurrently, C and B exist concurrently, D and B exist concurrently, C and D exist concurrently, A, B and C exist concurrently, A, B and D exist concurrently, A, C and D exist concurrently, B, C and D exist concurrently, and A, B, C and D exist concurrently.

The terms “first”, “second”, “third”, “fourth”, etc. in the present disclosure are merely for the purpose of description and should not be construed as indicating or implying relative importance. The term “a plurality of” means two or more, unless otherwise expressly provided.

In several embodiments provided by the present disclosure, it should be understood that the disclosed devices and methods are implemented in other means. For example, the device embodiments described above are merely schematic. For example, the partitioning of units may only be logical functional partitioning. There are other partitioning modes during actual implementation. For example, a plurality of units or components are combined or integrated into another system, or some features are ignored or not executed. In addition, mutual coupling or direct coupling or communication connection that is shown or discussed may be indirect coupling or communication connection through some interfaces, devices or units, and may be in electrical, mechanical or other forms.

The units described as separated components may be or may not be physically separated. The components displayed as units may be or may not be physical units, that is, may be located in one place or may be distributed on a plurality of network units. Part or all of the units may be selected according to actual needs to achieve the purposes of the solutions of the embodiments.

A person of ordinary skill in the art may understand that all or part of the steps in the above embodiments can be completed through hardware, or through relevant hardware instructed by a program which may be stored in a computer-readable storage medium, such as a read-only memory, a disk or an optical disc.

The above descriptions are merely alternative embodiments of the present disclosure, and are not intended to limit the present disclosure. Any modifications, equivalent replacements, improvements and the like made within the principles of the present disclosure shall be included within the scope of protection of the present disclosure.

1. A display device, comprising a display panel, a first control assembly, and a memory, wherein
the display panel comprises a substrate, and a target circuit structure and a plurality of light-emitting units which are disposed on the substrate, wherein the substrate is provided with a first display region and a second display region, the first display region surrounding the second display region; the plurality of light-emitting units are disposed in both the second display region and the first display region; and the target circuit structure is electrically connected to the plurality of light-emitting units;
the memory stores target compensation values for a plurality of sub-pixels in the second display region, wherein the target compensation values for the plurality of sub-pixels are compensation values corresponding to the target circuit structure;
the first control assembly is configured to obtain the target compensation values for the plurality of sub-pixels from the memory and compensate for the plurality of sub-pixels in the second display region based on the target compensation values; and
the target compensation values for the plurality of sub-pixels comprise target compensation values for the plurality of sub-pixels at first specified luminance, wherein the target compensation values at the first specified luminance are configured to make a luminance difference between the plurality of sub-pixels in the second display region and sub-pixels in the first display region conform to target luminance data upon compensating for the plurality of sub-pixels in the second display region.

2. The display device according to claim 1, wherein the memory further stores at least one conversion coefficient; and
the first control assembly is configured to obtain the at least one conversion coefficient from the memory, and determine target compensation values for the plurality of sub-pixels at other specified luminance except the first specified luminance based on the at least one conversion coefficient and the target compensation values for the plurality of sub-pixels at the first specified luminance.

3. The display device according to claim 2, wherein the memory stores seven conversion coefficients; and
the first control assembly is configured to obtain the seven conversion coefficients from the memory, and determine target compensation values for the plurality of sub-pixels at other seven kinds of specified luminance except the first specified luminance based on the seven conversion coefficients and the target compensation values for the plurality of sub-pixels at the first specified luminance, the first specified luminance and the seven kinds of specified luminance being uniformly distributed in a luminance range of the display panel.

4. The display device according to claim 1, wherein the target compensation values for the plurality of sub-pixels are compensation values corresponding to display devices of same manufacturing lot having the target circuit structure.

5. A compensation system of a display device, comprising a display device and a compensation device, wherein
the display device comprises a display panel, a first control assembly, and a memory, wherein the display panel comprises a substrate, and a target circuit structure and a plurality of light-emitting units which are disposed on the substrate, wherein the substrate is provided with a second display region and a first display region outside the second display region; the plurality of light-emitting units are disposed in both the second display region and the first display region; and the target circuit structure is electrically connected to the plurality of light-emitting units; and
the compensation device is configured to:
obtain temporary compensation values for a plurality of sub-pixels in the second display region at first specified luminance based on a compensation value determination process;
add the temporary compensation values for the plurality of sub-pixels in the second display region to candidate compensation values for the plurality of sub-pixels in the second display region;
compensate for the plurality of sub-pixels in the second display region with the candidate compensation values;
determine whether a luminance difference between the second display region and the first display region conforms to target luminance data;
execute a step of obtaining the temporary compensation values for the plurality of sub-pixels in the second display region at the first specified luminance based on the compensation value determination process in a case that the luminance difference does not conform to the target luminance data;
determine the candidate compensation values for the plurality of sub-pixels as target compensation values for the plurality of sub-pixels at the first specified luminance in a case that the luminance difference conforms to the target luminance data; and
store the target compensation values for the plurality of sub-pixels at the first specified luminance into the memory of the display device, wherein
the compensation value determination process comprises:
compensating for the plurality of sub-pixels with the candidate compensation values and controlling the display panel to display image data of the first specified luminance;
obtaining luminance parameters of the plurality of sub-pixels in the second display region and a luminance parameter of the first display region; and
determining the temporary compensation values based on difference values between the luminance parameters of the plurality of sub-pixels and the luminance parameter of the first display region.

6. The compensation system according to claim 5, wherein the compensation device comprises a second control assembly and an image acquisition assembly, wherein
the image acquisition assembly is configured to:
acquire images of the plurality of sub-pixels in the second display region and an image in the first display region in a case that the display panel displays the image data of the first specified luminance; and
the second control assembly is configured to:
determine the luminance parameters of the plurality of sub-pixels based on the images of the plurality of sub-pixels in the second display region; and
determine the luminance parameter of the first display region based on the image in the first display region.

7. The compensation system according to claim 5, wherein the image acquisition assembly is configured to:
shoot an image in the second display region and in at least part of the first display region surrounding the second display region in a case that the display panel displays the image data of the first specified luminance.

8. The compensation system according to claim 5, wherein the second control assembly is configured to:
determine a luminance mean of the first display region based on the image in the first display region; and
determine the luminance parameter of the first display region based on the luminance mean.

9. The compensation system according to claim 5, wherein the compensation device is configured to:
obtain conversion coefficients between the target compensation values for the plurality of sub-pixels at the first specified luminance and other target compensation values, wherein the other target compensation values are target compensation values for the plurality of sub-pixels at specified luminance except the first specified luminance; and
store the conversion coefficients in the memory of the display device.

10. The compensation system according to claim 5, wherein the second control assembly is configured to:
determine the temporary compensation values according to a preset formula, the preset formula comprising:
$$pD 1 = lv {1}_{t}^{\frac{1}{g}} - lv {1}_{p}^{\frac{1}{g}} ,$$
wherein pD1 is a temporary compensation value for a first sub-pixel in the plurality of sub-pixels, lv1ₜ is the luminance parameter of the first display region, lv1ₚ is a luminance parameter of the first sub-pixel, and g is a gamma value of the display device.

11. The compensation system according to claim 5, wherein the plurality of light-emitting units comprises at least a blue light-emitting unit for emitting blue light, a green light-emitting unit for emitting green light, and a red light-emitting unit for emitting red light; and
the target compensation values comprise a blue light compensation value for the blue light-emitting unit, a green light compensation value for the green light-emitting unit and a red light compensation value for the red light-emitting unit.

12. A method for determining compensation values, applicable to a compensation system of a display device, wherein the compensation system comprises a display device and a compensation device configured to compensate for the display device; and the display device comprises a display panel, a first control assembly, and a memory, wherein the display panel comprises a substrate, and a target circuit structure and a plurality of light-emitting units which are disposed on the substrate, wherein the substrate is provided with a second display region and a first display region outside the second display region; the plurality of light-emitting units are disposed in both the second display region and the first display region; and the target circuit structure is electrically connected to the plurality of light-emitting units; and
the method comprises:
obtaining temporary compensation values for a plurality of sub-pixels in the second display region at first specified luminance based on a compensation value determination process;
adding the temporary compensation values for the plurality of sub-pixels to candidate compensation values for the plurality of sub-pixels;
compensating for the plurality of sub-pixels with the candidate compensation values;
determining whether a luminance difference between the second display region and the first display region conforms to target luminance data;
executing a step of obtaining the temporary compensation values for the plurality of sub-pixels in the second display region at the first specified luminance based on the compensation value determination process in a case that the luminance difference does not conform to the target luminance data; and
determining the candidate compensation values for the plurality of sub-pixels as target compensation values for the plurality of sub-pixels at the first specified luminance in a case that the luminance difference conforms to the target luminance data, wherein
the compensation value determination process comprises:
compensating for the plurality of sub-pixels with the candidate compensation values and controlling the display panel to display image data of the first specified luminance;
obtaining luminance parameters of the plurality of sub-pixels in the second display region and a luminance parameter of the first display region; and
determining the temporary compensation values based on difference values between the luminance parameters of the plurality of sub-pixels and the luminance parameter of the first display region.

13. The method according to claim 12, wherein obtaining the luminance parameters of the plurality of sub-pixels in the second display region and the luminance parameter of the first display region comprises:
acquiring images of the plurality of sub-pixels in the second display region and an image in the first display region in a case that the display panel displays the image data of the first specified luminance;
determining the luminance parameters of the plurality of sub-pixels based on the images of the plurality of sub-pixels in the second display region; and
determining the luminance parameter of the first display region based on the image in the first display region.

14. The method according to claim 12, further comprising:
obtaining conversion coefficients between the target compensation values for the plurality of sub-pixels at the first specified luminance and other target compensation values, wherein the other target compensation values are target compensation values for the plurality of sub-pixels at other specified luminance except the first specified luminance; and
storing the conversion coefficients in the memory of the display device.

15. The method according to claim 12, wherein determining the temporary compensation values based on the difference values between the luminance parameters of the plurality of sub-pixels and the luminance parameter of the first display region comprises:
determining the temporary compensation values according to a preset formula, the preset formula comprising:
$$pD 1 = lv {1}_{t}^{\frac{1}{g}} - lv {1}_{p}^{\frac{1}{g}} ,$$
where pD1 is a temporary compensation value for a first sub-pixel in the plurality of sub-pixels, lv1ₜ is the luminance parameter of the first display region, lv1ₚ is a luminance parameter of the first sub-pixel, and g is a gamma value of the display device.

16. The method according to claim 12, wherein the plurality of light-emitting units comprises at least a blue light-emitting unit for emitting blue light, a green light-emitting unit for emitting green light, and a red light-emitting unit for emitting red light; and
the target compensation values comprise a blue light compensation value for the blue light-emitting unit, a green light compensation value for the green light-emitting unit and a red light compensation value for the red light-emitting unit.
